(19) United States
(12) Patent Application Publication
(10) Pub. No.: US 2012/0040202 A1
(43) Pub. Date: Feb. 16, 2012

(54) COATED MAGNETIC ALLOY MATERIAL AND METHOD FOR THE MANUFACTURE THEREOF

(76) Inventors: Julia Lyubina, London (RU); Mihaela Buschbeck, Nurnberg (DE); Oliver Gutfleisch, Dresden (DE)

(21) Appl. No.: 13/139,137

(22) PCT Filed: Dec. 10, 2009
(86) PCT No.: PCT/EP09/66871

§ 371 Date: Sep. 30, 2011

(30) Foreign Application Priority Data
Dec. 11, 2008 (DE) 10 2008 054 522.8

(51) Int. Cl. H01F 1/01; B05D 1/02; B05D 1/18; B05D 3/00; B32B 15/04; B32B 15/01; B32B 15/02; C25D 3/56; C25D 3/12; C25D 3/26; C25D 3/04; C25D 3/38; C25D 3/22; C25D 3/46; C25D 3/50; C25D 3/48; B05D 5/00

(52) U.S. Cl. 428/553; 427/127; 428/611; 428/607; 428/570; 428/457; 205/261; 205/238; 205/271; 205/281; 205/283; 205/269; 205/291; 205/305; 205/265; 205/263; 205/264; 205/266

(57) ABSTRACT

The invention relates to the field of materials science and material physics and relates to a coated magnetic alloy material, which can be used, for example, as a magnetic cooling material for cooling purposes. The object of the present invention is to disclose a coated magnetic alloy material, which has improved mechanical and/or chemical properties. The object is attained with a magnetic alloy material with a NaZn₁₃ type crystal structure and a composition according to the formula RₐFe_{100-a-x-y-z}TₓM_{y}L_{z} and the surface of which is coated with a material composed of at least one element from the group Al, Si, C, Sn, Ti, V, Cd, Cr, Mn, W, Co, Ni, Cu, Zn, Pd, Ag, Pt, Au or combinations thereof The object is furthermore attained by a method in which the magnetic alloy material is coated by means of a method from the liquid phase.

The invention relates to the field of materials science and material physics and relates to a coated magnetic alloy material, which, for example, can be used as a magnetic cooling material (magnetocaloric material) for cooling purposes or for energy-producing purposes, and a method for the production thereof.

Magnetic cooling by magnetic alloy materials presents an environmentally friendly, energy-effective and cost-effective alternative to conventional gas compression cooling. Magnetic cooling is based on the magnetocaloric effect (MCE) in which a temperature change takes place as a result of the change of the magnetization of the material. Materials with a large MCE in particular are of interest for applications.

Magnetic materials having a NaZn₁₃ type crystal structure thereby show a particularly large MCE, which is caused by a thermally-induced and field-induced phase change from the paramagnetic to the ferromagnetic state near to the Curie temperature T_{c} of the material.

Magnetic alloy materials of the NaZn₁₃ type crystal structure are known and could be used as magnetic cooling materials. The composition of materials of this type can be given by the formula R(Tᵢ₋ₐMₐ)₁₃H_{d}, in which rare earth elements or a combination of rare earth elements are used for R, Fe or a combination of Fe and Co are used for T, and Al, Si, Ga or Ge or combinations thereof are used for M. 0.05≦a≦0.2 applies for a and 0≦d≦3.0 applies for d. Materials of this type have very good magnetocaloric properties at temperatures close to the Curie temperature and are classified as promising candidates for magnetic cooling (C. Zimm et al., Int. J. Refrigeration 29 (2006) 1302-1306).

Magnetic alloy materials of this type of the NaZn₁₃ type are further known with compositions according to the formula Fe_{100-a-b-c}RₐA_{b}TM_{c} where R=rare earths from the group La, Ce, Pr, Nd, Pm, Sm, Eu, Gd, Tb, Dy, Ho, Er and Tm with at least 90 atom % La, where A=at least one element from Al, Si, Ga, Ge, Sn, and where TM=at least one transition element from Sc, Ti, V, Cr, Mn, Co, Ni, Cu and Zn, where 5≦a≦10, 4.7≦b≦18 and 0≦c≦9 (all atom %) (DE 103 38 467 A1, US 2007/0137732 A1, US 2004/007944 A1, US 7,186,303 B2, US 2006/0231163 A1, US 2005/0172643 A1, WO 2008/099234 A1).

As is known, magnetic alloys of this type are produced by means of an arc-melting method or a high-frequency melting method and subsequently heat-treated for, e.g., approx. 168 h at approx. 1050° C. under vacuum (DE 103 38 467 A1). It is likewise possible to melt the alloy elements at 1200 to 1800° C., then to cool the alloy at cooling speeds of 10² to 10⁶° C./s (quickly solidify) and subsequently to thermally treat the quickly solidified alloy (US 2006/0076084 A1; A. Yan, K.-H. Muller, O. Gutfleisch, J. Appl. Phys. 97 (2005) 036102; X. B. Liu, Z. Altounian, G. H. Tu, J. Phys.: Condens. Matter 16 (2004) 8043.).

An important disadvantage of the known magnetic alloy materials of the NaZn₁₃ type is their poor mechanical properties, in particular their low ductility and mechanical integrity, and low corrosion resistance. The conditions of use and the selection of the heat transfer media are greatly restricted thereby.

The object of the present invention is to disclose a coated magnetic alloy material, which with comparable magnetic and/or magnetocaloric properties has improved mechanical and/or chemical properties compared to the materials of the prior art, and to disclose an effective method for coating the magnetic alloy material, in which the application temperature of this magnetic alloy material is realized by adjusting the Curie temperature in relatively wide limits.

The object is attained through the invention disclosed in the claims. Advantageous embodiments are the subject matter of the subordinate claims.

The coated magnetic alloy material according to the invention is composed of a magnetic alloy material having the NaZn₁₃ type crystal structure and a composition according to the formula:

RₐFe_{100-a-x-y-z}TₓM_{y}L_{z}

where
R=La or a combination of La with Ce, Pr, Nd, Sm, Gd, Tb, Dy, Ho, Er, Tm, Yb, Lu and/or Y,
T=at least one element selected from the group Sc, Ti, V, Cr, Mn, Co, Ni, Cu and/or Zn,
M=Al, Si, P, Ga, Ge, In and/or Sn,
L=H, B, C and/or N,
5≦a≦11 and 0.3≦x≦12 and 2≦y≦20 and 0.2≦z≦18, (all in atom %),
and the surface of which is coated with a material, composed of at least one element from the group Al, Si, C, Sn, Ti, V, Cd, Cr, Mn, W, Co, Ni, Cu, Zn, Pd, Ag, Pt, Au or combinations thereof.

Advantageously, ≧35% by volume, even more advantageously at least 50% by volume and even more advantageously 80-90% by volume of the magnetic alloy material has a NaZn₁₃ type crystal structure.

Likewise advantageously, to change the Curie temperature of the magnetic alloy material, the condition 2≦z≦15 atom % and/or 3≦y≦16 and/or 0.5≦x≦9 is realized, wherein with varying z and/or y and/or x content the Curie temperature changes between 170 K and 400 K.

It is also advantageous if the magnetic alloy material is present in the form of a band, a wire, a plate, a film or a flake, a needle, a foam or in the form of particles.

It is also advantageous if the layer thickness of the coating is selected depending on the size of the magnetocaloric effect of the alloy material, wherein even more advantageously the layer thickness is ≧0.5 μm to ≦50 μm.

It is furthermore advantageous if one or more adhesive layers are present between the magnetic alloy material and the coating.

It is likewise advantageous if the surface of the uncoated alloy material is etched.

With the method according to the invention for producing a coated magnetic alloy material, the magnetic alloy material is coated by means of a method from the liquid phase.

Advantageously, the coating from the liquid phase is realized by electrochemical coating, electroless plating, immersing, centrifuging, spraying and/or spreading.

Likewise advantageously, the coating is applied by electrochemical coating or electroless plating.

With the solution according to the invention it is possible for the first time to disclose a magnetic alloy material, the mechanical and chemical properties of which, in particular the elastic strength and corrosion resistance, have been considerably improved while retaining the good magnetic properties regarding the magnetocaloric effect. This is achieved according to the invention by a coating of the surface of the magnetic alloy material, wherein one or more further layers, such as adhesive layers, for example, can be present between the surface of the magnetic alloy material and the coating. Prior etching can be carried out for better adhesion. With a layer structure of this type, and also regarding the layer thickness of the layers as a whole, it should be ensured that they should have only dimensions such that the magnetocaloric effect of the magnetic alloy material is still achieved to the desired extent. For example, a much higher layer thickness of the coating can be applied with a solid plate of the magnetic alloy material, since the magnetocaloric effect is not impaired or only slightly impaired by the larger volume of the alloy material. Inversely, the layer thickness may be very small only when the magnetic alloy material is a thin metal band, for example. One skilled in the art is aware of this connection per se and he is able to easily select the corresponding layer thicknesses of the coating according to the invention according to the concrete conditions of use. In general, however, the smallest possible layer thickness of the coating according to the invention is desirable in order to influence the size of the magnetocaloric effect of the magnetic material as little as possible.

The coating according to the invention exhibits much better mechanical properties than the magnetic alloy material, which leads overall to considerable improvements in the applications of the material according to the invention of the coated magnetic alloy material. Likewise, through the complete coating of the magnetic material the surface thereof is protected against corrosive attack by various heat exchanging media, so that therefore the selection of the media is no longer dependent on the magnetic alloy material. The possibilities of use are also considerably improved thereby.

The solution according to the invention shows in particular improved results in the predominant use of magnetic alloy materials having a NaZn₁₃ type crystal structure. These materials show a large magnetocaloric effect, as is known, and can therefore be used particularly advantageously.

It is likewise advantageous if the solution according to the invention is used for magnetic alloy materials that have a composition according to the formula RₓT_{100-x-y-z}M_{y}L_{z} with the known elements, combinations of elements and fractions.

It is particularly advantageous thereby if in particular H, B, C and/or N are present in the alloy material. These elements are incorporated into interstitial positions, as is known, and act in particular on the Curie temperature T_{c} important for magnetic alloy materials, which Curie temperature determines the application temperature, as is known, in that with an increasing content of these elements, and in particular H thereby, the Curie temperature is increased. An application temperature for the magnetic alloy material can thus be adjusted within relatively wide limits.

With the coating method from the liquid phase according to the invention, such as electrochemical coating or coating by electroless plating, at the same time hydrogen can be introduced into the crystal lattice interstitially or elements such as, e.g., Co, Ni, Cu can substitute Fe by diffusion processes and thereby increase the Curie temperature T_{c}. The hydrogen can be produced in a secondary reaction, such as, e.g., as a byproduct of a cathodic electrode reaction or can be released during the oxidation of the reducing agent. This effect is thus also shown in the solution according to the invention in a virtually unchanged manner, so that in addition to improved mechanical and chemical properties, also improved primary properties, such as application temperature and size of the MCE can be achieved with the solution according to the invention.

Furthermore, the coating can be applied onto the surface of the magnetic alloy material regardless of the respectively concrete form of the magnetic alloy material. The coating method to be used is to be selected depending on the present form of the magnetic alloy material, advantageously as a band, wire, plate, film, flake, needle, foam or particle.

Electrochemical coating or electroless plating have proven to be particularly advantageous, since with these methods the coating can be applied in a simple manner in the desired layer thickness onto all geometric shapes of the magnetic alloy material. At the same time, with this method the introduction of hydrogen or elements such as, e.g., Co and Ni to adjust the Curie temperature by means of diffusion processes is also easily possible.

The coating methods are industrially widespread and therefore also very cost-effective, so that materials in unlimited quantity can be coated uniformly and on all sides. The coating methods do not require a vacuum or a special atmosphere and they are used at temperatures between room temperature and approx. 80° C.

Another advantage of electroless plating is the possibility of coating materials by immersing them in a solution without the application of external current. An autocatalytic process based on the oxidation of a reducing agent and the reduction of cations thereby takes place on the sample surface of the material to be deposited.

The invention is explained in more detail below based on several exemplary embodiments.

### EXAMPLE 1

An alloy with the composition LaFe_{11.6}Si_{1.4} is produced from the elements La, Fe and Si by means of an arc melting process. The alloy is subsequently rapidly solidified with the surface speed of the copper wheel of 30 m/s and thereafter heat-treated at 1050° C. for 1 hour [A. Yan, K. -H. Muller, O. Gutfleisch, J. Appl. Phys. 97 (2005) 036102]. The resulting material is in the form of a band with a thickness of 60 μm and is composed to 90% by weight of the NaZn₁₃ type phase and to 10% by weight of α-Fe.

A layer of Ni 1 μm thick is applied to this band by means of electroless plating for 30 minutes. The electroless plating is carried out from a solution heated to 80° C. with the composition conforming to A. Brenner [A. Brenner et al., Res. Natl. Bur. Std. 37 (1946) 31; Proc. Am. Electroplaters' Soc., 33 (1946) 23] at a pH value of 9.

The bands coated with Ni show an increase in elastic strength of at least 25% compared to uncoated bands.

With the coating of the band, the band is now corrosion resistant with respect to heat transfer media of oily, alcoholic or aqueous solutions. The mass loss, determined by measurements in 0.01 M sulfuric acid (pH=2), shows a much higher stability of the coated band compared to that of an uncoated material. The uncoated material shows a change in the mass by 15% after only 3 minutes' immersion in the solution and after 5 minutes is no longer mechanically stable, so that it disintegrates into smaller pieces and ultimately, after 10 minutes' immersion, into powder. Meanwhile the band coated according to the invention shows a mass loss of less than 1% even after 40 minutes' immersion in the solution and remains mechanically stable.

Furthermore, the above-mentioned test illustrates the improvement of the mechanical properties of the band with respect to the heat transfer media.

At the same time as the Ni coating described above, atomic hydrogen is produced on the material surface through the oxidation of the reducing agent (sodium hypophosphite). The hydrogen diffuses into the material and is subsequently incorporated into the interstitial positions of the NaZn₁₃ type phase. The influence of the Ni coating described above on the magnetic properties of the LaFe1_{11.6}Si_{1.4} alloy is explained below.

The uncoated LaFe1_{11.6}Si_{1.4} alloy exhibits an entropy change ΔSₘₐₓ 145 kJ/m³K at 193 K and a magnetic field change of 2 tesla. The half width is thereby 8.3 K and the relative cooling capacity is 1.5 MJ/m³.

The simultaneous hydrogenation of the LaFe_{11.6}Si_{1.4} alloy by the coating process renders possible an increase in the Curie temperature of the starting material from 185K to 330K. After the coating with Ni, which simultaneously leads to the diffusion of hydrogen, the temperature at which the maximum of the entropy change takes place shifts to 330K. With a magnetic field change of 2 tesla, the maximum entropy change is ΔSₘₐₓ=110 kJ/m³K, the half width is 7.5 K and the relative cooling capacity is 1.0 MJ/m³. This change in the magnetic properties is attributable to the diffusion of hydrogen into the interstitial crystal lattice positions of the La(Fe,Si)₁₃ phase. The hydrogen analysis by means of hot extraction yields a hydrogen concentration that corresponds to a composition of LaFe_{11.6}Si_{1.4}H_{1.63}.

### EXAMPLE 2

An alloy with the composition LaFe_{11.6}Si_{1.4} is produced from the elements La, Fe and Si by means of an arc melting process. The alloy is subsequently rapidly solidified with the surface speed of the copper wheel of 30 m/s and thereafter heat-treated at 1050° C. for 1 hour. The resulting material is in the form of a band with a thickness of 60 μm and is composed to 90% by weight of NaZn₁₃ type phase and 10% by weight of α-Fe.

A Co layer 1 μm thick is applied onto this band by potentiostatic coating from a 0.5 M cobalt sulfate solution at −1.2 V (measured against saturated calomel reference electrode) over 5 minutes at room temperature. A Pt sheet is used as a counterelectrode.

After the coating with Co, the temperature at which the maximum of the entropy change occurs shifts from 185 K to 200 K. With a magnetic field change of 2 tesla, the maximum entropy change is ΔSₘₐₓ=125 kJ/m³K, the half width is 8.3 K and the relative cooling capacity is 1.2 MJ/m³. This change in the magnetic properties is attributable to the diffusion of Co into the crystal lattice of the La(Fe,Si)₁₃ phase.

### EXAMPLE 3

A tablet-shaped solid material with the composition LaFe_{11.6}Co_{0.2}Si_{1.2} and the dimensions of approx. 5 mm diameter×2 mm height is produced from the elements La, Fe, Co and Si through an arc melting and subsequent heat treatment at 1050° C. for 18 days. The resulting material is composed to 87% by weight of the NaZn₁₃ type phase and to 13% by weight of α-Fe. This alloy is hydrogenated at 400° C. in 5 bar hydrogen gas. The hydrogen concentration of z=1.6 was measured by means of hot extraction. This corresponds to a composition of LeFe_{11.6}Co_{0.2}Si_{1.2}H_{1.6}.

A layer of Ni 1 μm thick is applied to this LeFe_{11.6}Co_{0.2}Si_{1.2}H_{1.6} alloy by 30 minutes' electroless plating. The electroless plating is carried out from a solution heated to 80° C. with the composition conforming to A. Brenner [A. Brenner et al., Res. Natl. Bur. Std. 37 (1946) 31; Proc. Am. Electroplaters' Soc., 33 (1946) 23] at a pH value of 9.

With this coating of the tablet it is now also corrosion-resistant with respect to the heat transfer media of oily, alcoholic or aqueous solutions. The mass loss, determined by measurements in 0.01 M sulfuric acid (pH=2) shows a much higher stability of the coated tablet compared to that of an uncoated material. The uncoated material shows a change in the mass of 5% after 30 minutes' immersion in the solution. Meanwhile, the tablet coated according to the invention shows a mass loss of less than 1% even after 30 minutes' immersion in the solution.

1. Alloy material according to claim 1, in which the magnetic alloy material has a NaZn₁₃ type crystal structure and a composition according to the formula:
RₐFe_{100-a-x-y-z}TₓM_{y}L_{z}
where
R=La or a combination of La with Ce, Pr, Nd, Sm, Gd, Tb, Dy, Ho, Er, Tm, Yb, Lu and/or Y,
T=at least one element selected from the group Sc, Ti, V, Cr, Mn, Co, Ni, Cu and/or Zn,
M=Al, Si, P, Ga, Ge, In and/or Sn,
L=H, B, C and/or N,
5≦a≦11 and 0.3≦x≦12 and 2≦y≦20 and 0.2≦z≦18, (all in atom %),
and the surface of which is coated with a material, composed of at least one element from the group Al, Si, C, Sn, Ti, V, Cd, Cr, Mn, W, Co, Ni, Cu, Zn, Pd, Ag, Pt, Au or combinations thereof.

2. Alloy material according to claim 1, in which ≧35% by volume of the magnetic alloy material has a NaZn₁₃ type crystal structure.

3. Alloy material according to claim 2, in which at least 50% by volume of the magnetic alloy material has a NaZn₁₃ type crystal structure.

4. Alloy material according to claim 3, in which 80-90% by volume of the magnetic alloy material has a NaZn₁₃ type crystal structure.

5. Alloy material according to claim 1, in which to change the Curie temperature of the magnetic alloy material, the conditions 2≦z≦15 atom % and/or 3≦y≦16 and/or 0.5≦x≦9 are realized, wherein with varying z and/or y and/or x content the Curie temperature changes between 170 K and 400 K.

6. Alloy material according to claim 1, in which the magnetic alloy material is present in the form of a band, a wire, a plate, a film or a flake, a needle, a foam or in the form of particles.

7. Alloy material according to claim 1, in which the layer thickness of the coating is selected depending on the size of the magnetocaloric effect of the alloy material.

8. Alloy material according to claim 7, in which the layer thickness of the coating is ≧0.5 μm to ≦50 μm.

9. Alloy material according to claim 1, in which one or more adhesive layers are present between the magnetic alloy material and the coating.

10. Alloy material according to claim 1, in which the surface of the uncoated alloy material is etched.

11. Method for producing a coated magnetic alloy material according to at least one of claims 1 through 10, in which the magnetic alloy material is coated from the liquid phase.

12. Method according to claim 11, in which the coating from the liquid phase is realized by electrochemical coating, electroless plating, immersing, centrifuging, spraying and/or spreading.

13. Method according to claim 12, in which the coating is applied by electrochemical coating or electroless plating.
